(19) United States
(12) Patent Application Publication
(10) Pub. No.: US 2024/0317021 A1
(43) Pub. Date: Sep. 26, 2024

(54) METHOD FOR OPERATING A REFRIGERANT CIRCUIT SYSTEM FOR A VEHICLE, A REFRIGERANT CIRCUIT SYSTEM FOR CARRYING OUT THE METHOD AND A VEHICLE HAVING THE SAME

(71) Applicant: MAHLE INTERNATIONAL GMBH, Stuttgart (DE)

(72) Inventors: Uli Christian BLESSING, Donnbronn (DE); Markus BOGER, Stuttgart (DE); Matthias JUNG, Stuttgart (DE)

(21) Appl. No.: 18/611,963

(22) Filed: Mar. 21, 2024

(30) Foreign Application Priority Data
Mar. 23, 2023 (DE) 102023202669.4

(51) Int. Cl. B60H 1/00

(52) U.S. Cl. CPC B60H 1/00885

(57) ABSTRACT

A refrigerant circuit system, in particular a heat pump system, wherein the refrigerant circuit system has a refrigerant circuit, in which a refrigerant circulates and which is divided into a high-pressure area and a low-pressure area, wherein the refrigerant circuit system has a compressor for compressing the refrigerant arranged in the refrigerant circuit is provided. A pressure and temperature value of the refrigerant in the low-pressure area is measured by a pressure and temperature sensor arranged in the low-pressure area and then a pressure value of the refrigerant in the high-pressure area is determined by the measured pressure and temperature value and a provided compressor characteristic map of the compressor. A refrigerant circuit system for a vehicle is provided and is configured to carry out the method and a vehicle, in particular an electrically powered vehicle, which is equipped with such a refrigerant circuit system.

### CROSS-REFERENCE TO RELATED APPLICATIONS

This application claims priority from German Patent Application No. DE 102023202669.4, filed Mar. 23, 2023, the entirety of which is hereby incorporated by reference herein.

The invention relates to a method for operating a refrigerant circuit system for a vehicle according to claim 1. The invention relates in particular to a refrigerant circuit system for carrying out the method as well as further in particular a vehicle having such a refrigerant circuit system.

Refrigerant circuit systems for vehicles, in particular battery electric vehicles, are ordinarily used to air-condition a vehicle interior, which may be supplied with a conditionable air-conditioned air by means of the refrigerant circuit system. Such refrigerant circuit systems have a refrigerant circuit, in which a refrigerant circulates. When circulating through the refrigerant circuit, the refrigerant undergoes a phase transition from liquid to gaseous and back again. As a rule, known refrigerant circuit systems possess a plurality of sensors, which continuously monitor the pressure and temperature values of the circulating refrigerant. Frequently, combined sensors are used for simultaneous measurement of pressure and temperature. The measured pressure and temperature values are used on a high-pressure side of the refrigerant circuit system to ensure operation of the refrigerant circuit system with respect to permissible maximum pressures and/or permissible maximum temperatures. On a low-pressure side of the refrigerant circuit system, the measured pressure and temperature values are used to ensure operation with respect to permissible minimum pressures and permissible minimum temperatures. At the same time, the measured pressure and temperature values may be used for an efficient and/or performance-optimized control of the refrigerant circuit system and components or subsystems of the vehicle connected thereto. Such refrigerant circuit systems are relatively difficult to install and in addition, relatively costly, in particular due to the large number of integrated sensors, although one wishes for systems that are easy to install and cost-effective.

Therefore, the problem addressed by the invention is that of providing an improved or at least another embodiment for a method for operating a refrigerant circuit system, which permits a simple and inexpensive production of the refrigerant circuit system. In particular, the aforementioned disadvantages should be remedied. Furthermore, in particular, a refrigerant circuit system should be specified that is comparatively easy and inexpensive to produce. In addition, in particular, a vehicle should be provided which has such a refrigerant circuit system.

This invention solves this problem, in particular, via the subject matters of the independent claims. Advantageous subject matters are the subject matter of the dependent claims and of the description.

The invention has recognized that a refrigerant circuit system can be produced and operated with a lower number of sensors for measuring pressure and/or temperature values vis-à-vis known systems when a pressure and/or temperature value is determined in a high-pressure area of the refrigerant circuit system on the basis of a measured pressure and temperature value in a low-pressure area of the refrigerant circuit system and on the basis of a known compressor characteristic map of the compressor instead of being measured with an additional sensor in the high-pressure area.

Thus, the invention proposes a method for operating a refrigerant circuit system for a vehicle, in particular, a battery electric vehicle, in which the refrigerant circuit system has a refrigerant circuit, in which a refrigerant can circulate and which is divided into a high-pressure area and a low-pressure area. The refrigerant circuit system can in particular be implemented as a heat pump system. The refrigerant circuit system has in addition a compressor arranged in the refrigerant circuit through which refrigerant can flow to compress the refrigerant. It is essential that a pressure and temperature value of the refrigerant is measured in the low-pressure area on the basis of a pressure and temperature sensor arranged in the low-pressure area of the refrigerant circuit system, wherein a pressure value of the refrigerant in the high-pressure area is determined or derivable on the basis of the measured pressure and temperature value of the refrigerant in the low-pressure area and a compressor characteristic map of the compressor determined and provided for example during the development of the refrigerant circuit system at the factory.

By means of the proposed method, the measurement of a pressure value of the refrigerant in the high-pressure area and a pressure sensor used up to now for this purpose in the high-pressure area are omitted. In other words, the pressure value of the refrigerant in the high-pressure area is no longer measured. In very general terms, the pressure value of the refrigerant in the high-pressure area is derived from measured system variables of the refrigerant circuit system and from component properties determined prior to operation. Hence, a kind of virtual pressure sensor is provided for the high-pressure area of the refrigerant circuit. This has the advantage that a correspondingly operated refrigerant circuit system for a vehicle can be equipped with fewer sensors and therefore can be provided and operated more cost-effectively than was previously the case. Due to the reduced number of sensors, such a refrigerant circuit system is also easier to install.

The method can be utilized for refrigerant circuit systems, which can be operated in a heating mode referred to as the first operating mode, and in a cooling mode different from the first operating mode, referred to as the second operating mode. In the first operating mode, i.e., in the heating mode, air-conditioned air can be heated by means of the refrigerant circuit system. On the other hand, in the second operating mode, i.e., in the cooling mode, air-conditioned air can be cooled. However, the proposed method can also be utilized on refrigerant circuit systems which provide merely a cooling function. In other words, there is no heating mode, but rather only a cooling mode.

The determination of said pressure value of the refrigerant in the high-pressure area can be carried out with the aid of a controller of the refrigerant circuit system. The controller of the refrigerant circuit system expediently comprises commands, which, in the event of their execution, cause the refrigerant circuit system to carry out the present method. Expediently, the sensors of the refrigerant circuit system, in particular the pressure and temperature sensor, provide the measured pressure and temperature values to the controller. Further expediently, the compressor characteristic map of the compressor is implemented in the controller.

For example, the invention understands the term pressure value of the refrigerant to mean an absolute pressure or a relative pressure of the refrigerant. Furthermore, the invention expediently understands a temperature value of the refrigerant to mean a temperature of the refrigerant.

Expediently, provision is made that on the basis of the measured pressure and temperature value of the refrigerant in the low-pressure area as well as the compressor characteristic map of the compressor, in addition, a temperature value of the refrigerant in the high-pressure area is determined or derived. In other words, now, in addition to the determined pressure value of the refrigerant in the high-pressure area, a temperature value of the refrigerant in the high-pressure area is also determined or derived. As a result, a temperature sensor used in the high-pressure area for measuring temperature values of the refrigerant in the high-pressure area or a pressure and temperature sensor for simultaneously measuring pressure and temperature values of the refrigerant in the high-pressure area can be omitted. In other words, the temperature value of the refrigerant in the high-pressure area is no longer measured. In this case, the refrigerant circuit system has, as it were, a purely virtual pressure and temperature sensor in the high-pressure area. This has the advantage that a refrigerant circuit system for a vehicle can be operated with even fewer sensors than up to this point. As a result, the refrigerant circuit system can be provided even more cost-effectively and can be installed more easily.

Furthermore, provision can be expediently made that a temperature value of the refrigerant in the high-pressure area is measured by means of a temperature sensor of the refrigerant circuit system arranged in the high-pressure area, wherein on the basis of the measured pressure and temperature value of the refrigerant in the low-pressure area, the compressor characteristic map of the compressor and the pressure value of the refrigerant in the high-pressure area is determined on the basis of the measured temperature value of the refrigerant in the high-pressure area. The measured temperature value in the high-pressure area of the refrigerant circuit can be used in addition to the measured pressure and temperature value of the refrigerant in the low-pressure area to determine the pressure value in the high-pressure area. As a result, for example the determination of the pressure value in the high-pressure area can occur more precisely, i.e., with a lower difference to the actual pressure value in the high-pressure area.

In this context, it can be expedient if the temperature sensor arranged in the high-pressure area is implemented as an indirect surface temperature sensor. This indirect surface temperature sensor can be arranged on a surface of a high-pressure line arranged in the high-pressure area, wherein a temperature value of the refrigerant in the high-pressure area is indirectly measured by means of the surface temperature sensor. Such a surface temperature sensor can be provided cost-effectively and may be installed relatively easily, with a minimum of installation effort on a high-pressure line, for example using conventional fixing means such as fastening screws or the like. No special adjustments of the high-pressure line are necessary. The temperature value measured by the surface temperature sensor can be corrected if necessary by an offset value which can be determined during the development of the refrigerant circuit system.

Alternatively, provision can be made that the temperature sensor arranged in the high-pressure area is implemented as a direct temperature sensor. This can be arranged within a high-pressure line arranged in the high-pressure area, in such a way that the direct temperature sensor is moistened by the refrigerant. As a result, a temperature value of the refrigerant in the high-pressure area can be directly measured by means of the temperature sensor. A temperature value of the refrigerant, in particular a change of the temperature value, can as a result be recorded relatively quickly and relatively accurately.

Expediently, the invention understands the term compressor characteristic map of the compressor, for example in the development of the refrigerant circuit system, to be an assignment instruction specified by the manufacturer, by means of which, together with a measured pressure and temperature value in the low-pressure area, a pressure and temperature value in the high-pressure can be determined or derived.

Further expediently, provision is made that the compressor characteristic map of the compressor is formed by one or more compressor characteristics, which describe the operational behavior of the compressor in a predefined operating range of the compressor and on the basis of which an assignment of a state of the refrigerant at an entry area of the compressor assigned to the low-pressure area can be carried out to a state of the refrigerant at an exit area of the compressor assigned to the high-pressure area. The operational behavior of the compressor is characterized in particular by its operating variables. For example, operating variables of the compressor can be its power consumption, its speed, a mass flow of refrigerant, an achievable pressure ratio between the entry area and the exit area of the compressor, operating points of the compressor and high-pressure conditions of the compressor. The state of the refrigerant at the entry area of the compressor is depicted in particular by its pressure, temperature and density. The state of the refrigerant at the exit area of the compressor is depicted in particular by its pressure, temperature and density. The entry area of the compressor can be formed by an inlet line. The exit area of the compressor can be formed by an outlet line. In the development of the refrigerant circuit system by the manufacturer, the compressor characteristics can be specially defined for the compressor used in the refrigerant circuit system.

Further expediently, provision is made that a pressure value of the refrigerant is determined in the high-pressure area and/or a temperature value of the refrigerant in the high-pressure area on the basis of the measured pressure and temperature value of the refrigerant in the low-pressure area and/or on the basis of the measured temperature value of the refrigerant in the high-pressure area and on the basis of the compressor characteristic map of the compressor. As a result, an assignment of the measured pressure and temperature value of the refrigerant in the low-pressure area and/or the measured temperature value of the refrigerant in the high-pressure area to a non-measured pressure value of the refrigerant in the high-pressure area and/or a non-measured temperature value of the refrigerant in the high-pressure area is carried out on the basis of the measured pressure and temperature value of the refrigerant in the low-pressure area and/or on the basis of the measured temperature value of the refrigerant in the high-pressure area and on the basis of at least one compressor characteristic of the compressor characteristic map. As a result, a pressure and/or temperature value of the refrigerant in the high-pressure area can be reliably determined on the basis of a compressor characteristic of the compressor characteristic map, without having to install a pressure and/or temperature sensor in the high-pressure area.

Provision can be made that the pressure and temperature value of the refrigerant in the low-pressure area directly upstream of the compressor is measured on the basis of the pressure and temperature sensor. Preferably, provision can be further made that the pressure and temperature sensor is a component of the compressor. In so doing, the pressure and temperature sensor can be arranged in the low-pressure area of the compressor.

Expediently, provision is made that the refrigerant circuit system has an air-conditioning unit, in practice referred to as HVAC (heating, ventilation, and air conditioning), arranged in the refrigerant circuit, with a condenser arranged in the high-pressure area and through which refrigerant can flow for transferring heat from the high-pressure area to an air-conditioned air, wherein an exit area of the compressor assigned to the high-pressure area by means of a high-pressure line of the refrigerant circuit system through which refrigerant can flow is connected to an entry area of the condenser, so that refrigerant can flow from the compressor to the condenser. In the process, the determined pressure value of the refrigerant in the high-pressure area is determined as a pressure value of the refrigerant within the high-pressure line or as a pressure value of the refrigerant within the exit area of the compressor or as a pressure value of the refrigerant within the entry area of the condenser. Alternatively, or in addition, the determined temperature value of the refrigerant in the high-pressure area can be determined as a temperature value of the refrigerant within the high-pressure line or as a temperature value of the refrigerant within the exit area of the compressor or as a temperature value of the refrigerant within the entry area of the condenser. As a result, the pressure value and/or temperature value of the refrigerant in the high-pressure area is determined within the high-pressure line or within the compressor or within the entry area of the condenser. The entry area of the condenser can be formed by an inlet line.

According to a further basic principle of the invention, a refrigerant circuit system is provided for a vehicle, in particular a battery electric vehicle, which is configured to carry out the foregoing described method. Expediently, the refrigerant circuit system can implement a heat pump system. Provision is made that the refrigerant circuit system is embodied to be operable in a first and second operating mode and to be switchable between these two operating modes, wherein the refrigerant circuit system has a refrigerant circuit, in which a refrigerant can circulate and which is divided into a high-pressure area and a low-pressure area. Furthermore, provision is made that the refrigerant circuit system has a compressor arranged in the refrigerant circuit through which refrigerant can flow to compress the refrigerant, which forms a transition from the low-pressure area to the high-pressure area and which fluidically connects the high-pressure area to the low-pressure area. By means of a pressure and temperature sensor arranged in the low-pressure area of the refrigerant circuit system, a pressure and temperature value of the refrigerant in the low-pressure area can be measured. On the basis of the measurable pressure and temperature value and a compressor characteristic map of the compressor, a pressure value of the refrigerant in the high-pressure area can be determined or derived. As a result, an advantageous refrigerant circuit system is specified, which, on the basis of the foregoing described method, can be operated with fewer pressure and temperature sensors than comparable refrigerant circuit systems. The refrigerant circuit system can therefore be provided more cost-effectively and can be installed more easily than up to this point.

Expediently, provision is made that a temperature sensor of the refrigerant circuit is arranged in the high-pressure area, by means of which a temperature value of the refrigerant in the high-pressure area can be measured. On the basis of the measurable pressure and temperature value of the refrigerant in the low-pressure area, the measurable temperature value of the refrigerant in the high-pressure area and a compressor characteristic map of the compressor, a pressure value of the refrigerant in the high-pressure area can be determined or derived. Provision can be made that the temperature sensor is implemented as an indirect surface temperature sensor, which is arranged on a surface of a high-pressure line arranged in the high-pressure area, wherein by means of the temperature sensor, a temperature value of the refrigerant in the high-pressure area can be indirectly measured. Alternatively, provision can be made that the temperature sensor is implemented as a direct temperature sensor, which is arranged within a high-pressure line arranged in the high-pressure area high-pressure line and is moistened by the refrigerant, so that a temperature value of the refrigerant in the high-pressure area can be directly measured.

The measured temperature value in the high-pressure area of the refrigerant circuit can be used in addition to the measured pressure and temperature value of the refrigerant in the low-pressure area to determine the pressure value in the high-pressure area. As a result, the determination of the pressure value in the high-pressure area can, for example, be carried out more precisely, i.e., with a lower difference to the actual pressure value in the high-pressure area.

It is particularly advantageous if the said surface temperature sensor is attached to a well-protected area of the refrigerant circuit system, so that it is protected from environmental influences like ambient temperatures, airflow, rainwater etc. To this end, the surface temperature sensor can for example be arranged at an inlet line of a condenser of an air-conditioning unit of the refrigerant circuit system arranged in the high-pressure area, referred to as HVAC (heating, ventilation, and air conditioning). As a result, the surface temperature sensor would for example be arranged in the interior of a cab or relatively close to a vehicle front panel and hence protected from environmental influences. In addition, this embodiment has the advantage that the surface temperature sensor can be connected to a vehicle on-board network of the vehicle relatively easily, since it can for example be connected to the vehicle on-board network by means of a wiring harness of the HVAC. Furthermore, the surface temperature sensor can be arranged on an exit area of the compressor assigned to the high-pressure area, for example of an outlet line.

Expediently, provision is made that the pressure and temperature sensor in the low-pressure area is arranged upstream of the compressor. The pressure and temperature sensor can be arranged in the low-pressure area, for example directly upstream of the compressor. As a result, a pressure value and temperature value in the low-pressure area can be measured, preferably directly upstream of the compressor.

Furthermore, provision can be made that no pressure sensor is arranged in the high-pressure area and/or that no temperature sensor is arranged in the high-pressure area. As a result, a refrigerant circuit system that can be provided cost-effectively is specified.

Further expediently, provision is made that an exit area of the compressor assigned to the high-pressure area by means of a high-pressure line of the refrigerant circuit system through which refrigerant can flow is connected to an entry area of the condenser, so that refrigerant can flow from the compressor to the condenser. In the process, it is expedient if no pressure sensor for measuring a pressure value is provided at the exit area of the compressor and/or at the high-pressure line and/or at the entry area of the condenser. Furthermore, it can be expedient if no temperature sensor for measuring a temperature value is provided at the exit area of the compressor and/or at the high-pressure line and/or at the entry area of the condenser. As a result, a refrigerant circuit system which can be provided cost-effectively is likewise specified, wherein no sensors for determining temperature values or pressure values are provided in the specified areas.

The invention furthermore proposes a vehicle, in particular a battery electric vehicle, which is equipped with a refrigerant circuit system designed according to the foregoing description, in particular a heat pump system. As a result, a vehicle is specified which is equipped with a refrigerant circuit system that can be provided cost-effectively.

In summary it should be noted: This invention relates preferably to a method for operating a refrigerant circuit system for a vehicle, in particular a heat pump system, wherein the refrigerant circuit system has a refrigerant circuit, in which a refrigerant circulates and which is divided into a high-pressure area and a low-pressure area, wherein the refrigerant circuit system has a compressor arranged in the refrigerant circuit through which refrigerant can flow to compress the refrigerant. Within the scope of the method, provision is made that, on the basis of a pressure and temperature sensor arranged in the low-pressure area of the refrigerant circuit system, a pressure and temperature value of the refrigerant in the low-pressure area is measured and then, on the basis of the measured pressure and temperature value of the refrigerant in the low-pressure area and a provided compressor characteristic map of the compressor, a pressure value of the refrigerant in the high-pressure area is determined. The invention furthermore relates to a refrigerant circuit system for a vehicle configured for carrying out the method according to the foregoing description and a vehicle, in particular an electrically powered vehicle, which is equipped with such a refrigerant circuit system.

Further important features and advantages of the invention arise from the subclaims, from the drawings and from the associated description of the figures on the basis of the drawings.

It should be understood that the features mentioned above and those to be explained below can be used not only in the combination indicated in each case, but also in other combinations or on their own, without departing from the scope of this invention.

Preferred embodiments of the invention are shown in the drawings and will be explained in more detail in the following description, wherein identical reference numerals refer to identical or similar or functionally identical components.

The figures show the following, in each case schematically

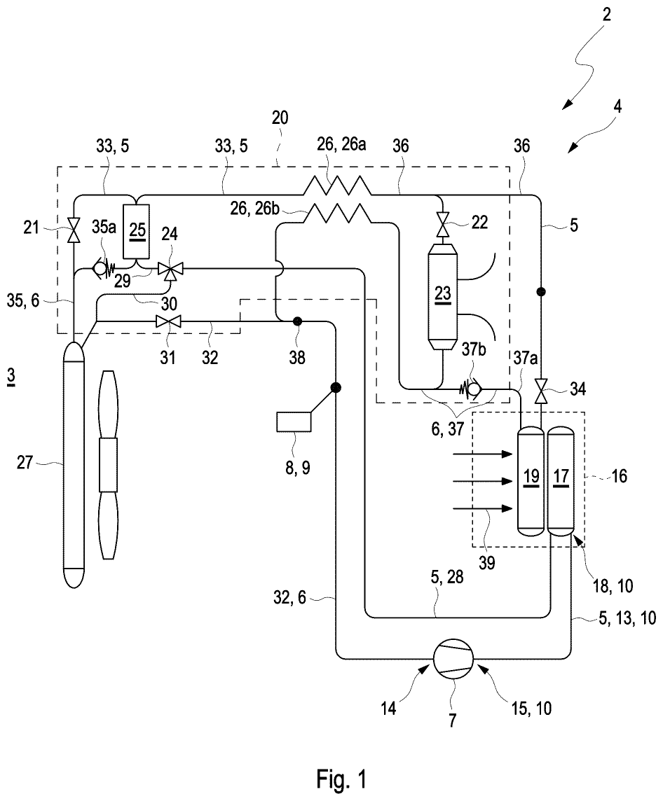

FIG. 1 shows a highly simplified and schematically represented embodiment of a refrigerant circuit system for a vehicle and

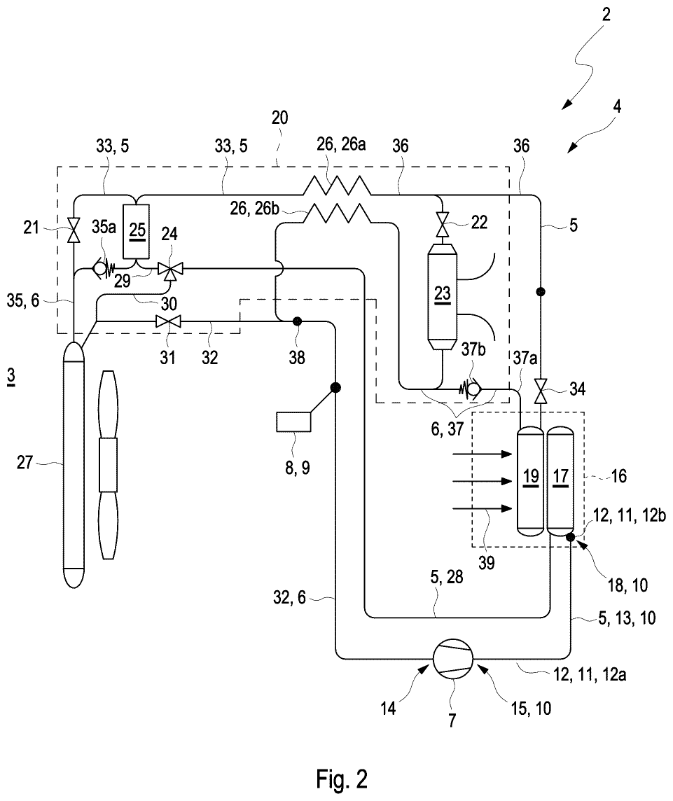

FIG. 2 shows a highly simplified and schematically represented further embodiment of a refrigerant circuit system for a vehicle.

FIGS. 1 and 2 each show a preferred embodiment of a refrigerant circuit system of a refrigerant circuit system referred to in its entirety with reference numeral 2 for a vehicle 3 not illustrated in greater detail, by means of which a vehicle interior of the vehicle 3 may be air-conditioned by cooling or heating an air-conditioned air 39 that can be supplied to the vehicle interior. Accordingly, the refrigerant circuit system 2 may be operated in a first operating mode (heating mode) and in a second operating mode (cooling mode) differing from the first operating mode. In the first operating mode (heating mode), the air-conditioned air 39 can be heated by means of the refrigerant circuit system 2, i.e., the air-conditioned air 39 is supplied with heat. On the other hand, in the second operating mode (cooling mode), the air-conditioned air 39 can be cooled, i.e., the air-conditioned air 39 heat is extracted. In addition, a dehumidifying operation is also possible by means of the refrigerant circuit system 2, in which the air-conditioned air 39 is first dried by cooling and then heated. With the wiring of the refrigerant circuit system 2 illustrated in FIGS. 1 and 2, both the first operating mode (heating mode) and the second operating mode (cooling mode) can be implemented.

According to FIG. 1, a highly simplified and schematically represented embodiment of the refrigerant circuit system 2 for a vehicle 3 can be recognized, which has a refrigerant circuit referred to in its entirety as 4, in which a refrigerant circulates and which is divided into a high-pressure area 5 and a low-pressure area 6. The refrigerant circuit system 2 has in addition a compressor 7 arranged in the refrigerant circuit 4, through which refrigerant can flow, for compressing the refrigerant, which forms a transition from the low-pressure area 6 to the high-pressure area 5 and fluidically connects these two areas 5, 6 to each other. The refrigerant circuit system 2 has in addition an air-conditioning unit 16 indicated by a dashed box, in practice referred to as HVAC (heating, ventilation, and air conditioning), which comprises an inner condenser 17 for transferring heat from the high-pressure area 5 to the air-conditioned air 39 represented in FIG. 1 by arrows, a vaporizer 19, through which refrigerant can flow and by means of which the refrigerant can be vaporized, and an expansion valve 34. By means of the air-conditioning unit 16, heated or cooled air-conditioned air 39 can be conducted to the vehicle interior. The refrigerant circuit system 2 has furthermore a heat pump device 20 indicated by a dashed box, the two expansion valves 21, 22, a heat exchanger 23 referred to in practice as a “chiller”, by means of which the refrigerant of the refrigerant circuit system 2 can be vaporized by absorbing heat from a coolant of the vehicle 3, a 3/2-way valve 24, a high-pressure refrigerant collector 25 for collecting and/or drying refrigerant as well as a so-called inner heat exchanger 26. The inner heat exchanger 26 has a section 26a arranged in the high-pressure area 5 and a section 26b arranged in the low-pressure area 6, as a result of which heat can be transferred between the high-pressure area 5 and the low-pressure area 6. The refrigerant circuit system 2 has in addition a so-called external heat exchanger 27 with fans for transferring heat from the refrigerant circuit system 2 to ambient air of the refrigerant circuit system 2.

According to FIG. 1, provision is furthermore made that an exit area 15 of the compressor 7 assigned to the high-pressure area 5 is connected to an entry area 18 of the inner condenser 17 by means of a high-pressure line 13 of the refrigerant circuit system 2 through which refrigerant can flow. As a result, compressed refrigerant can flow from the compressor 7 to the condenser 17. The condenser 17 is connected to the 3/2-way valve 24 by means of a further high-pressure line 28, said valve for its part being connected to the high-pressure refrigerant collector 25 by means of a further high-pressure line 29 as well as being connected by means of a pressure line 30 to the external heat exchanger 27 and a shut-off valve 31 for opening and closing the pressure line 30. The latter is connected to the compressor 7 by means of a low-pressure line 32. It should be mentioned that the pressure line 30 forms a high-pressure line in the cooling mode, since it then conducts refrigerant from the high-pressure line 28 to the external heat exchanger 27, while in the heating mode it forms a low-pressure line, since then fluid does not flow through it. Again, proceeding from the high-pressure refrigerant collector 25, it should be noted that the same is connected via a further high-pressure line 33 on the one hand to the first expansion valve 21 for the controlled expansion of refrigerant in a further pressure line 35, and on the other hand to section 26a of the inner heat exchanger 26 arranged in the high-pressure area 5.

Furthermore, it is evident in FIG. 1 that the said section 26a of the inner heat exchanger 26 is connected via a further high-pressure line 36 via the second expansion valve 22 to the heat exchanger 23 (chiller) and is connected via the third expansion valve 34 to the vaporizer 19. The heat exchanger 23 (chiller) and the vaporizer 19 are connected to a further low-pressure line 37, which for its part, flows into the low-pressure line 32 in forming a connection point 38, so that refrigerant can flow from the heat exchanger 23 (chiller) and vaporizer 19 into the low-pressure line 32. Proceeding from the connection point 38, refrigerant flows via an entry area 14 of the compressor 7 back into the compressor 7. Upstream of the compressor 7 a pressure and temperature sensor 8 is attached between the condenser 7 and the connection point 38, which is configured to measure a temperature value and pressure value of the refrigerant in the low-pressure area 6. It should be noted that a check valve 37b can be integrated into a section 37a of the further low-pressure line 37 connecting the heat exchanger 23 (chiller) and vaporizer 19. Moreover, it should be mentioned that the first expansion valve 21 and the high-pressure refrigerant collector 25 are connected to the external heat exchanger 27 by means of the further pressure line 35, so that refrigerant can flow proceeding from the first expansion valve 21 and/or the high-pressure refrigerant collector 25 to the external heat exchanger 27. A check valve 35a can be integrated into the further pressure line 35. Similar to the pressure line 30, the further pressure line 35 is also associated with either the high-pressure side (cooling mode) or the low-pressure side (heating mode) of the circuit, depending on the operating state.

In the first operating mode (heating mode), the refrigerant proceeding from the compressor 7 undergoes a compression, causing the pressure and temperature values of the refrigerant to rise. The compressed refrigerant subsequently exits the compressor 7 via its exit area 15 and is thus located in the high-pressure area 5 in said high-pressure line 13. Downstream of the high-pressure line 13 the refrigerant flows via an entry area 18 of the inner condenser 17 into the inner condenser 17 of the air-conditioning unit 16. It is worth noting that, according to this embodiment of the refrigerant circuit system 2, neither a pressure sensor for measuring a pressure value nor a temperature sensor for measuring a temperature value or a combined pressure and temperature sensor is provided at the exit area 15 of the compressor 7 and at the high-pressure line 13 and at the entry area 18 of the condenser 17 of the air-conditioning unit 16. At any rate, provision is made that the refrigerant condenses in the condenser 17 under discharge of heat to air-conditioned air 39 flowing to the vehicle interior. The condensed refrigerant then flows through the further high-pressure line 28 to the 3/2-way valve 24. In this operating mode, this is configured such that the refrigerant flows via the further high-pressure line 29 to the high-pressure refrigerant collector 25. Proceeding from the high-pressure refrigerant collector 25, the refrigerant then flows via the further high-pressure line 33 to the first expansion valve 21, by means of which the refrigerant is expanded such that, in the event of lower pressure and temperature values in the low-pressure area 6 of the refrigerant circuit 4, it is present in the further pressure line 35. The refrigerant can subsequently flow into the external heat exchanger 27 and vaporize there by absorbing heat from the environment. The refrigerant then flows from the external heat exchanger 27 through the pressure line 30, through the now opened shut-off valve 31 in the low-pressure line 32 and from there back into the compressor 7 by means of entry area 14 of the compressor 7.

Alternatively, or in addition, in the first operating mode (heating mode) the expansion at the second expansion valve 22, connected upstream of the heat exchanger 23 (chiller), can occur, wherein then the heat, as mentioned, is extracted from a coolant of the vehicle. In this case, a part of the refrigerant coming from the heat exchanger 23 (chiller) flows through the further low-pressure line 37 and the section 26b of the inner heat exchanger 26 arranged in the low-pressure area 6 to the connection point 38 back in the low-pressure line 32, so that refrigerant can flow from the heat exchanger 23 (chiller) to the compressor 7. In the mentioned dehumidifying operation, in addition the throttling of the refrigerant at the vaporizer 19 with subsequent vaporization of the refrigerant in this component is possible during cooling of the air-conditioned air. The refrigerant flowing through the vaporizer 19 subsequently flows together with the refrigerant flowing where necessary through the heat exchanger 23 (chiller) or the external heat exchanger 27.

In the second operating mode (cooling mode), provision is made that the refrigerant is first compressed by means of the compressor 7, as a result of which, its pressure and temperature values increase. Proceeding from the compressor 7 via the high-pressure line 13, the refrigerant subsequently reaches the condenser 17 of the air-conditioning unit 16, where however, no heat transfer to the air-conditioned air 39 occurs, since air does not flow through the condenser 17. Hence, the refrigerant remains in the gaseous state and reaches the 3/2-way valve 24 via the further high-pressure line 28, said valve now being configured such that the refrigerant is conducted in its entirety to the external heat exchanger 27. The shut-off valve 31, arranged downstream of the 3/2-way valve 24 and upstream of the compressor 7, is in the process closed, so that no refrigerant can flow. As a result, an unwanted direct backflow of refrigerant to the compressor 7 is prevented. Instead, refrigerant flows to the external heat exchanger 27, where it is condensed by emitting heat to the environment. The liquid refrigerant then reaches the high-pressure refrigerant collector 25. Subsequently, the refrigerant flows from the high-pressure refrigerant collector 25 through the inner heat exchanger 26, where it cools and from where it can flow via the second expansion valve 22, the heat exchanger 23 (chiller) and the vaporizer 19 to the low-pressure area 6. Downstream of the heat exchanger 23 (chiller) and the vaporizer 19, the refrigerant merges and flows via section 26b of the inner heat exchanger 26. Finally, the refrigerant is again conducted via the connection point 38 back to the entry area 14 of the compressor 7, wherein it passes the pressure and temperature sensor 8 for measuring the pressure and temperature values.

According to the proposed method, provision is made that by means of the pressure and temperature sensor 8 arranged in the low-pressure line 32 in the low-pressure area 6, a pressure and temperature value 9 of the refrigerant in the low-pressure area 6 is measured, wherein by means of the measured pressure and temperature value 9 of the refrigerant and a previously provided compressor characteristic map of the compressor 7, a pressure and temperature value 10 of the refrigerant is determined in the exit area 15 of the compressor 7 and/or in the high-pressure line 13 and/or in the entry area 18 of the condenser 17 in the high-pressure area 5. By means of the determined pressure and temperature value 10 of the refrigerant in the high-pressure area 5, the refrigerant circuit system 2 can be controlled or regulated, and in particular, permissible maximum pressures and/or permissible maximum temperatures in the high-pressure area 5 of the refrigerant circuit system 2 are monitored, wherein a pressure and temperature sensor arranged in the high-pressure area 5 can be dispensed with, which makes the refrigerant circuit system 2 comparatively cost-effective.

FIG. 2 illustrates a highly simplified and schematically represented further embodiment of the refrigerant circuit system 2 for a vehicle. It differs from the refrigerant circuit system 2 illustrated in FIG. 1 only in that a temperature sensor 12 in the refrigerant circuit system 2 is arranged in the high-pressure area 5 in the high-pressure line 13. A temperature value 11 of the refrigerant in the high-pressure area 5 can be measured by means of this temperature sensor 12. A pressure value 10 of the refrigerant in the high-pressure area 5 can be determined by means of the additional temperature value 11 in the high-pressure area 5, the measured pressure and temperature value 9 of the refrigerant in the low-pressure area 6 and the compressor characteristic map of the compressor 7. Due to the additional temperature value 11 in the high-pressure area 5, the determination of the pressure value 10 can occur more precisely, i.e., with a lower difference to the actual pressure value in the high-pressure area 5. For example, the temperature sensor 12 can be arranged in the high-pressure line 13 downstream of the compressor 7, which is represented by a reference numeral 12a in FIG. 2. Alternatively, the temperature sensor 12 can be arranged for example in or at the entry area 18 of the condenser 17, which is represented by a reference numeral 12b in FIG. 2.

This specification can be readily understood with reference to the following Numbered Paragraphs:

Numbered Paragraph 1. A method for operating a refrigerant circuit system (2) for a vehicle (3), in particular a heat pump system,
wherein the refrigerant circuit system (2) has a refrigerant circuit (4), in which a refrigerant can circulate and which is divided into a high-pressure area (5) and a low-pressure area (6),
wherein the refrigerant circuit system (2) has a compressor (7) for compressing the refrigerant arranged in the refrigerant circuit (4), through which refrigerant can flow,
wherein a pressure and temperature value (9) of the refrigerant in the low-pressure area (6) is measured by means of a pressure and temperature sensor (8) of the refrigerant circuit system (2) arranged in the low-pressure area (6),
wherein a pressure value (10) of the refrigerant in the high-pressure area (5) is determined by means of measured pressure and temperature value (9) of the refrigerant in the low-pressure area (6) and a compressor characteristic map of the compressor (7).

Numbered Paragraph 2. The method according to Numbered Paragraph 1, characterized in that
in addition, a temperature value (11) of the refrigerant in the high-pressure area (5) is determined by means of a measured pressure and temperature value (9) of the refrigerant in the low-pressure area (6) and the compressor characteristic map of the compressor (7).

Numbered Paragraph 3. The method according to Numbered Paragraph 1, characterized in that
a temperature value (11) of the refrigerant in the high-pressure area (5) is measured by means of a temperature sensor (12) of the refrigerant circuit system (2) arranged in the high-pressure area (5),
wherein the pressure value (10) of the refrigerant in the high-pressure area (5) is determined by means of a measured pressure and temperature value (9) of the refrigerant in the low-pressure area (6), the compressor characteristic map of the compressor (7) and by means of measured temperature value (11) of the refrigerant in the high-pressure area (5).

Numbered Paragraph 4. The method according to Numbered Paragraph 3, characterized in that
the temperature sensor (12) arranged in the high-pressure area (5) is implemented as an indirect surface temperature sensor, which is arranged on a surface of a high-pressure line (13) arranged in the high-pressure area (5), wherein a temperature value (11) of the refrigerant in the high-pressure area (5) is indirectly measured by means of temperature sensor (12), or
the temperature sensor (12) arranged in the high-pressure area (5) is implemented as a direct temperature sensor, which is arranged within a high-pressure line (13) arranged in the high-pressure area (5) and which is directly moistened by the refrigerant, wherein a temperature value (11) of the refrigerant in the high-pressure area (5) is directly measured by means of the temperature sensor (12).

Numbered Paragraph 5. The method according to any of the foregoing Numbered Paragraphs,

characterized in that
the compressor characteristic map of the compressor (7) is formed by one or more compressor characteristics, which describe the operational behavior of the compressor (7) in a predefined operating range of the compressor (7) and on the basis of which an assignment of a state of the refrigerant to an entry area (14) of the compressor assigned to the low-pressure area (6) (7) to a state of the refrigerant at an exit area (15) of the compressor (7) assigned to the high-pressure area (5) is carried out.

Numbered Paragraph 6. The method according to Numbered Paragraph 5, characterized in that
a pressure value (10) of the refrigerant in the high-pressure area (5) and/or a temperature value (11) of the refrigerant in the high-pressure area (5) is determined by means of the measured pressure and temperature value (9) of the refrigerant in the low-pressure area (6) and/or the measured temperature value (11) of the refrigerant in the high-pressure area (5) and the compressor characteristic map of the compressor (7), in that
an assignment of the measured pressure and temperature value (9) of the refrigerant is carried out in the low-pressure area (6) and/or the measured temperature value (11) of the refrigerant in the high-pressure area (5) to a non-measured pressure value (10) of the refrigerant in the high-pressure area (5) and/or a non-measured temperature value (11) of the refrigerant in the high-pressure area (5) by means of measured pressure and temperature value (9) of the refrigerant in the low-pressure area (6) and/or the measured temperature value (11) of the refrigerant in the high-pressure area (5) as well as by means of at least one compressor characteristic of the compressor characteristic map.

Numbered Paragraph 7. The method according to any of the foregoing Numbered Paragraphs,

characterized in that
the refrigerant circuit system (2) has an air-conditioning unit (16) arranged in the refrigerant circuit (4) with a condenser (17) arranged in the high-pressure area (5) and through which refrigerant can flow for transferring heat from the high-pressure area (5) to an air-conditioned air,
an exit area (15) of the compressor (7) assigned to the high-pressure area (5) is connected to an entry area (18) of the condenser (17) by means of a high-pressure line (13) of the refrigerant circuit system (2) through which refrigerant can flow, so that refrigerant can flow from the compressor (7) to the condenser (17),
wherein the determined pressure value (10) of the refrigerant in the high-pressure area (5) is determined as a pressure value (10) of the refrigerant within the high-pressure line (13) or as a pressure value (10) of the refrigerant within the exit area (15) of the compressor (7) or as a pressure value (10) of the refrigerant within the entry area (18) of the condenser (17), and/or
wherein the determined temperature value (11) of the refrigerant in the high-pressure area (5) is determined as a temperature value (11) of the refrigerant within the high-pressure line (13) or as a temperature value (11) of the refrigerant within the exit area (15) of the compressor (7) or as a temperature value (11) of the refrigerant within the entry area (18) of the condenser (17).

Numbered Paragraph 8. A refrigerant circuit system (2) for a vehicle (3), in particular a heat pump system configured for execution of the method according to any of the foregoing Numbered Paragraphs 1 to 7,
wherein the refrigerant circuit system (2) is embodied to be operable in a first and second operating mode and to be switchable between these two operating modes,
wherein the refrigerant circuit system (2) has a refrigerant circuit (4), in which a refrigerant can circulate and which is divided into a high-pressure area (5) and a low-pressure area (6),
wherein the refrigerant circuit system (2) has a compressor (7) for compressing the refrigerant arranged in the refrigerant circuit (4), through which refrigerant can flow, which forms a transition from the low-pressure area (6) to the high-pressure area (5) and fluidically connects the high-pressure area (5) to the low-pressure area (6),
wherein a pressure and temperature value (9) of the refrigerant in the low-pressure area (6) can be measured by means of a pressure and temperature sensor (8) of the refrigerant circuit system (2) arranged in the low-pressure area (6),
wherein a pressure value (10) of the refrigerant in the high-pressure area (5) can be determined on the basis of the measurable pressure and temperature value (9) of the refrigerant in the low-pressure area (6) and a compressor characteristic map of the compressor.

Numbered Paragraph 9. The refrigerant circuit system (2) according to Numbered Paragraph 8,

characterized in that
a temperature sensor (12) is arranged in the high-pressure area (5) of the refrigerant circuit system (2), by means of which a temperature value (11) of the refrigerant in the high-pressure area (5) can be measured, and wherein a pressure value (10) of the refrigerant in the high-pressure area (5) can be determined on the basis of the measurable pressure and temperature value (9) of the refrigerant in the low-pressure area (6), the measurable temperature value (11) of the refrigerant in the high-pressure area (5) and a compressor characteristic map of the compressor (7), and/or
wherein the temperature sensor (12) is implemented as an indirect surface temperature sensor, which is arranged on a surface of a high-pressure line (13) arranged in the high-pressure area (5), wherein a temperature value (11) of the refrigerant in the high-pressure area (5) can be indirectly measured by means of temperature sensor (12), or
wherein the temperature sensor (12) is implemented as a direct temperature sensor, which is arranged within a high-pressure line (13) arranged in the high-pressure area (5) and is moistened by the refrigerant, so that a temperature value (11) of the refrigerant in the high-pressure area (5) can be directly measured.

Numbered Paragraph 10. The refrigerant circuit system (2) according to Numbered Paragraph 8 or 9,

characterized in that
the pressure and temperature sensor (8) is arranged in the low-pressure area (6) upstream of the compressor (7).

Numbered Paragraph 11. The refrigerant circuit system (2) according to any of Numbered Paragraphs 8 to 10,

characterized in that
the pressure and temperature sensor (8) is a component of the compressor (7) and is arranged in the low-pressure area (6).

Numbered Paragraph 12. The refrigerant circuit system (2) according to any of Numbered Paragraphs 8 to 11,

characterized in that
no pressure sensor is arranged in the high-pressure area (5), and/or
no temperature sensor is arranged in the high-pressure area (5).

Numbered Paragraph 13. The refrigerant circuit system (2) according to Numbered Paragraph 11 or 12,

characterized in that
an exit area (15) of the compressor (7) assigned to the high-pressure area (5) is connected to an entry area (18) of the condenser (17) by means of a high-pressure line (13) of the refrigerant circuit system (2) through which refrigerant can flow, so that refrigerant can flow from the compressor (7) to the condenser (17),
wherein no pressure sensor for measuring a pressure value is provided at the exit area (15) of the compressor (7) and/or at the high-pressure line (13) and/or at the entry area (18) of the condenser (17), and/or
wherein no temperature sensor for measuring a temperature value is provided at the exit area (15) of the compressor (7) and/or at the high-pressure line (13) and/or at the entry area (18) of the condenser (17).

Numbered Paragraph 14. A vehicle (3), in particular an electrically powered vehicle, which is equipped with a refrigerant circuit system (2) according to any of Numbered Paragraphs 8 to 13.

1. A method for operating a refrigerant circuit system for a vehicle, in particular a heat pump system,
wherein the refrigerant circuit system comprises a refrigerant circuit, in which a refrigerant can circulate and which is divided into a high-pressure area and a low-pressure area,
wherein the refrigerant circuit system further comprises a compressor for compressing the refrigerant arranged in the refrigerant circuit, through which refrigerant can flow,
wherein a pressure and temperature of the refrigerant in the low-pressure area is measured by with a pressure and temperature sensor provided in the low-pressure area,
wherein a pressure value of the refrigerant in the high-pressure area is determined by means of measured pressure and temperature of the refrigerant in the low-pressure area and a compressor characteristic map of the compressor.

2. The method according to claim 1,
wherein, a temperature of the refrigerant in the high-pressure area is determined by means of the measured pressure and temperature value of the refrigerant in the low-pressure area and the compressor characteristic map of the compressor.

3. The method according to claim 1,
wherein a temperature of the refrigerant in the high-pressure area is measured by means of a temperature sensor of the refrigerant circuit system arranged in the high-pressure area,
wherein the pressure of the refrigerant in the high-pressure area is determined by means of the measured pressure and temperature value of the refrigerant in the low-pressure area, the compressor characteristic map of the compressor and by means of measured temperature of the refrigerant in the high-pressure area with the temperature sensor in the high-pressure area.

4. The method according to claim 3,
wherein
the temperature sensor arranged in the high-pressure area is an indirect surface temperature sensor, which is disposed on a surface of a high-pressure line within the high-pressure area, wherein a temperature of the refrigerant in the high-pressure area is indirectly measured by the sensor, or
the temperature sensor arranged in the high-pressure area is a direct temperature sensor, which is disposed within a high-pressure line within in the high-pressure area and which is directly moistened by the refrigerant, wherein a temperature of the refrigerant in the high-pressure area is directly measured by the temperature sensor.

5. The method according to claim 1,
wherein the compressor characteristic map of the compressor is formed by one or more compressor characteristics, which describe the operational behavior of the compressor in a predefined operating range of the compressor and on the basis of which an assignment of a state of the refrigerant to an entry area (14) of the compressor assigned to the low-pressure area to a state of the refrigerant at an exit area of the compressor assigned to the high-pressure area is carried out.

6. The method according to claim 5,
wherein
a pressure of the refrigerant in the high-pressure area and/or a temperature of the refrigerant in the high-pressure area is determined by the measured pressure and temperature of the refrigerant in the low-pressure area and/or the measured temperature of the refrigerant in the high-pressure area and the compressor characteristic map of the compressor, in that
an assignment of the measured pressure and temperature of the refrigerant is carried out in the low-pressure area and/or the measured temperature value of the refrigerant in the high-pressure area to a non-measured pressure of the refrigerant in the high-pressure area and/or a non-measured temperature of the refrigerant in the high-pressure area by the measured pressure and temperature of the refrigerant in the low-pressure area and/or the measured temperature value) of the refrigerant in the high-pressure area as well as by at least one compressor characteristic of the compressor characteristic map.

7. The method according to claim 1,
wherein
the refrigerant circuit system comprises an air-conditioning unit disposed
in the refrigerant circuit with a condenser disposed in the high-pressure area and through which refrigerant can flow for transferring heat from the high-pressure area to an air-conditioned air,
an exit area of the compressor assigned to the high-pressure area is connected to an entry area of the condenser by a high-pressure line of the refrigerant circuit system through which refrigerant can flow, so that refrigerant can flow from the compressor to the condenser,
wherein the determined pressure of the refrigerant in the high-pressure area is determined as a pressure of the refrigerant within the high-pressure line or as a pressure of the refrigerant within the exit area of the compressor or as a pressure of the refrigerant within the entry area of the condenser, and/or
wherein the determined temperature of the refrigerant in the high-pressure area is determined as a temperature of the refrigerant within the high-pressure line or as a temperature of the refrigerant within the exit area of the compressor or as a temperature of the refrigerant within the entry area of the condenser.

8. A refrigerant circuit system for a vehicle, in particular a heat pump system configured for execution of the method according to claim 1,
wherein the refrigerant circuit system is operable in a first and second operating mode and to be switchable between these two operating modes,
wherein the refrigerant circuit system comprises a refrigerant circuit, in which a refrigerant can circulate and which is divided into a high-pressure area and a low-pressure area,
wherein the compressor for compressing the refrigerant arranged in the refrigerant circuit, through which refrigerant can flow, forms a transition from the low-pressure area to the high-pressure area and fluidically connects the high-pressure area to the low-pressure area.

9. The refrigerant circuit system according to claim 8,
wherein
a temperature sensor is provided in the high-pressure area of the refrigerant circuit system, and wherein a pressure of the refrigerant in the high-pressure area can be determined on the basis of the measurable pressure and temperature of the refrigerant in the low-pressure area, the measurable temperature of the refrigerant in the high-pressure area and a compressor characteristic map of the compressor, and/or
wherein the temperature sensor is implemented as an indirect surface temperature sensor, which is disposed on a surface of a high-pressure line within the high-pressure area, wherein a temperature of the refrigerant in the high-pressure area can be indirectly measured by the temperature sensor, or
wherein the temperature sensor is implemented as a direct temperature sensor, which is disposed within a high-pressure line in the high-pressure area and is moistened by the refrigerant, so that the temperature of the refrigerant in the high-pressure area can be directly measured.

10. The refrigerant circuit system according to claim 8,
wherein the pressure and temperature sensor is disposed in the low-pressure area upstream of the compressor.

11. The refrigerant circuit system according to claim 8,
wherein the pressure and temperature sensor is a component of the compressor and is disposed in the low-pressure area.

12. The refrigerant circuit system according to claim 8,
wherein no pressure sensor is disposed in the high-pressure area, and/or no temperature sensor is disposed in the high-pressure area.

13. The refrigerant circuit system according to claim 11,
wherein
an exit area of the compressor assigned to the high-pressure area is connected to an entry area of the condenser by a high-pressure line of the refrigerant circuit system through which refrigerant can flow, so that refrigerant can flow from the compressor to the condenser,
wherein no pressure sensor for measuring a pressure is provided at the exit area of the compressor and/or at the high-pressure line and/or at the entry area of the condenser, and/or
wherein no temperature sensor for measuring a temperature value is provided at the exit area of the compressor and/or at the high-pressure line and/or at the entry area of the condenser.

14. A vehicle, in particular an electrically powered vehicle, which is equipped with a refrigerant circuit system according to claim 8.
